(19) United States
(12) Patent Application Publication
(10) Pub. No.: US 2013/0146435 A1
(43) Pub. Date: Jun. 13, 2013

(54) KEY STRUCTURE OF A KEYBOARD

(71) Applicant: Ching-Cheng TSAI, New Taipei City (TW)

(72) Inventor: Ching-Cheng TSAI, New Taipei City (TW)

(73) Assignee: Chicony Electronics Co., Ltd.

(21) Appl. No.: 13/316,436

(22) Filed: Dec. 9, 2011

(51) Int. Cl. H01H 13/14; H01H 13/02

(52) U.S. Cl. 200/517; 200/344

(57) ABSTRACT

A key structure of a keyboard includes a base plate, a keycap, and an elastic body sandwiched between the base plate and the keycap. The elastic body has a neck portion. One end of the neck portion is provided with a bowl-shaped support toward the base plate, and the other end of the neck portion extends toward the keycap to form a flange. The outer peripheral dimension of the flange is larger than that of the outer peripheral dimension of the neck portion. With the flange being sandwiched between the keycap and the neck portion, the flange can exert an even force to the neck portion even through the keycap is subjected to an uneven external force, thereby preventing the neck portion from inclining or swaying. Thus, the convenience in using the keyboard and the stability during its operation can be improved greatly.

### BACKGROUND OF THE INVENTION

1. Field of the Invention

The present invention relates to a key structure, and in particular to a key structure of a keyboard.

2. Description of Prior Art

With the rapid advancement of science and technology, computers are widely used in our daily life. Most of the computers, such as desktop computers and notebook computers need to cooperate with a keyboard during their operation for allowing a user to input characters or commands. Thus, the keyboard is a necessary input peripheral device of personal computers for inputting characters, symbols or numerals. Further, some consumptive electronic products used in our daily life and some large-sized machining apparatuses used in the industrial industry also have a key structure as an input means, so that the user can input characters or commands into the consumptive electronic products or the machining apparatuses for operation.

FIG. 1 shows a conventional computer keyboard, which includes a keycap 10, a base plate 20, and a restoring body 30. The restoring body 30 is sandwiched between the keycap 10 and the base plate 20. The restoring body 30 has a head portion 301 abutting against the keycap 10. A bowl-shaped support 302 extends from the head portion 301 toward the base plate 20. A contact protrusion 303 extends from the interior of the bowl-shaped support 302. The base plate 20 is provided with a circuit switch 201 corresponding to the contact protrusion 303. The bowl-shaped support 302 separates the contact protrusion 303 from the circuit switch 210 to generate a space therebetween. By this arrangement, when the keycap 10 is pressed, the restoring body 30 is subjected to an elastic deformation, which achieves the electrical connection between the contact protrusion 303 and the circuit switch 201 and thus generates a signal corresponding to this action of pressing the keycap 10.

However, since the electronic products are made more and more compact, the key structure has to be made smaller accordingly. When the user presses one side edge of a key structure, since the dimension of the head portion 301 is small, so that such a small head portion 310 cannot generate a sufficient supporting force, which causes the keycap 10 to incline toward the pressed one side edge. As show in FIG. 1, the head portion 301 is in an inclined state. As a result, the contact protrusion 303 is also inclined accordingly. At this time, when the keycap 10 is pressed, the restoring body 30 is deformed to press the circuit switch 201, but the contact protrusion 303 may be deviated from the position of the circuit switch 201, so that the contact portion 303 cannot contact the circuit switch 201 accurately. As a result, the signal generated by pressing the keycap becomes poor. On the other hand, if the keycap 10 is used for a long period of time with the head portion 301 inclined, the head portion 301 is prone to generate a plastic deformation (rather than elastic deformation) to form a permanent inclination, so that the key structure cannot restore to a flat and level state. Thus, the user feels inconvenient in using the keyboard.

In view of this, the present Inventor proposes a novel and reasonable structure based on his expert knowledge and deliberate researches.

### SUMMARY OF THE INVENTION

The present invention is to provide a key structure of a keyboard, in which a neck portion of an elastic body is provided with a flange, so that the flange can still exert an even force to the neck portion to prevent the neck portion from inclining or swaying even when the keycap is subjected an uneven external force. In this way, the present invention can increase the convenience in using the keyboard and the stability during its operation.

The present invention provides a key structure of a keyboard, including: a base plate, a keycap, and an elastic body sandwiched between the base plate and the keycap. The elastic body has a neck portion. One end of the neck portion is provided with a bowl-shaped support toward the base plate, and the other end of the neck portion extends toward the keycap to form a flange. The outer peripheral dimension of the flange is larger than that of the outer peripheral dimension of the neck portion.

The present invention further provides a key structure of a keyboard, including: a base plate, a keycap, and an elastic body sandwiched between the base plate and the keycap. The elastic body has a neck portion. One end of the neck portion is provided with a bowl-shaped support toward the base plate. The present invention further includes a flange fixed to the keycap. The outer peripheral dimension of the flange is larger than that of the outer peripheral dimension of the neck portion. The flange is provided with an engaging portion. The engaging portion is engaged with the neck portion, thereby clamping the flange between the keycap and the neck portion.

The present invention has advantageous features as follows. The outer peripheral dimension of the flange is larger than that of the outer peripheral dimension of the neck portion. Further, the flange is clamped between the keycap and the neck portion, so that the flange can exert an even force to the neck portion even when the keycap is subjected to an uneven external force. In this way, the neck portion is prevented from deforming, inclining or swaying and thus the pressing portion is prevented from swaying or inclining, thereby making the pressing portion to abut against the membrane switch accurately. Thus, the convenience in using the keyboard and the stability during its operation are increased. Further, since the flange can exert an even force to the neck portion, the neck portion cannot generate a plastic deformation easily even through the keycap is subjected to an uneven external force for a long period of time. Thus, the lifetime of the key structure of the present invention is extended. When the keycap is pressed, the keycap is moved vertically toward the base plate together with a supporting element. Thus, when the keycap moves up and down, the keycap and the elastic body can be prevented from swaying leftwards or rightwards. Thus, the key structure of the present invention is very convenient in use, stable in its operation, and long in lifetime. Further, the inner peripheral dimension of the bowl-shaped support is larger than or equal to the outer peripheral dimension of the flange. By this arrangement, when the keycap is pressed, the flange can be prevented from affecting the deformation of the bowl-shaped support, so that the bottom area of the elastic body is larger than the top area of the elastic body, thereby avoiding uneven distribution of gravity force of the elastic body, i.e. a “top-heavy” phenomenon causing the swaying of the flange. Thus, the stability of the elastic body can be increased.

### BRIEF DESCRIPTION OF DRAWING

FIG. 1 is an assembled schematic view showing a conventional keyboard of a computer;

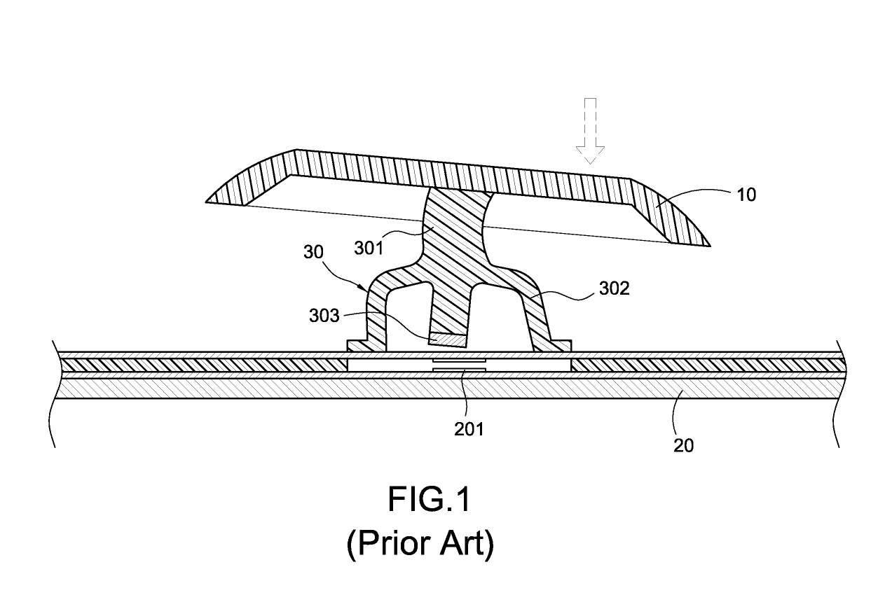

FIG. 2 is an exploded perspective view showing the key structure of the present invention;

FIG. 3 is an assembled view showing the key structure of the present invention;

FIG. 4 is a schematic view showing the operating state of key structure of the present invention;

FIG. 5 is an exploded perspective view showing the key structure of another embodiment of the present invention;

FIG. 6 is an assembled view showing the key structure of another embodiment of the present invention; and

FIG. 7 is an assembled view showing the key structure of a further embodiment of the present invention.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

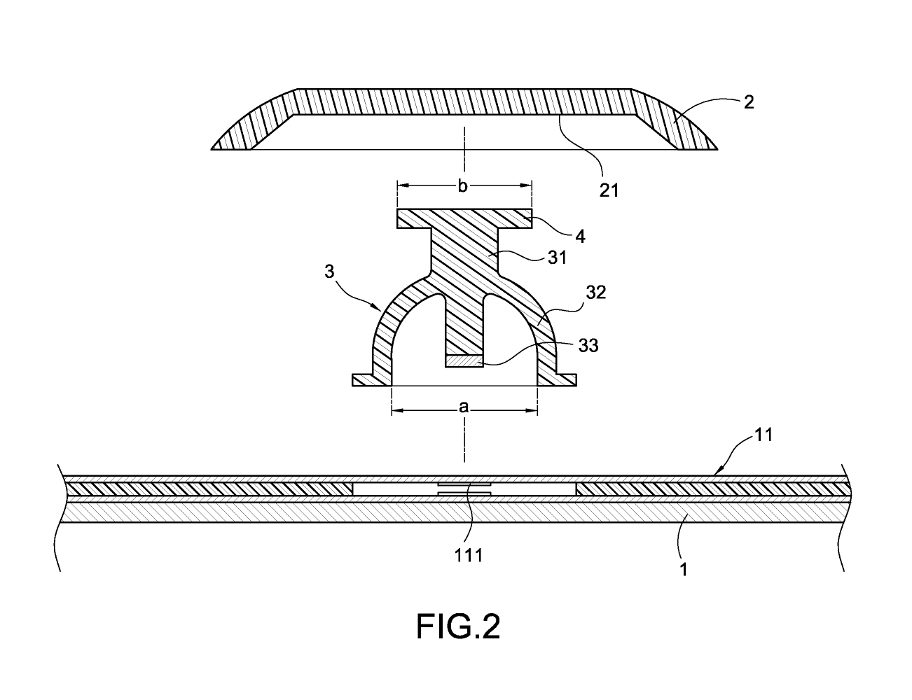

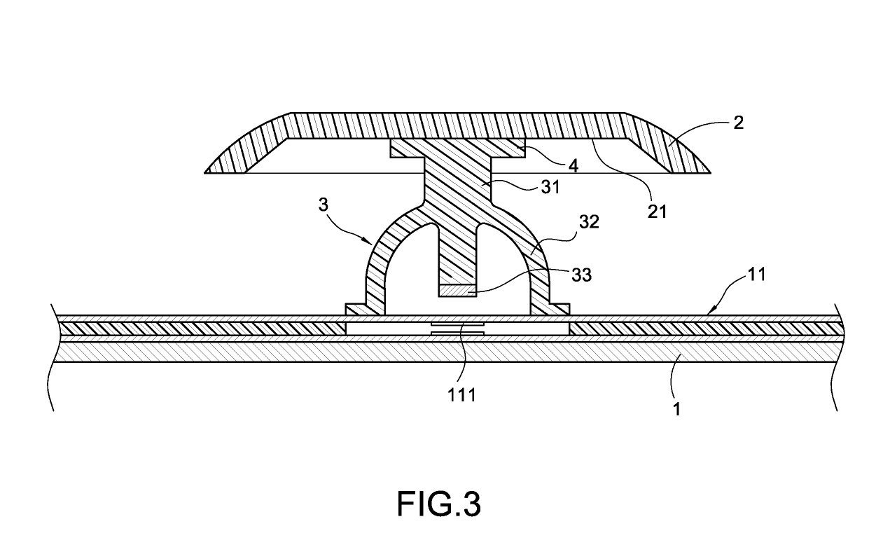

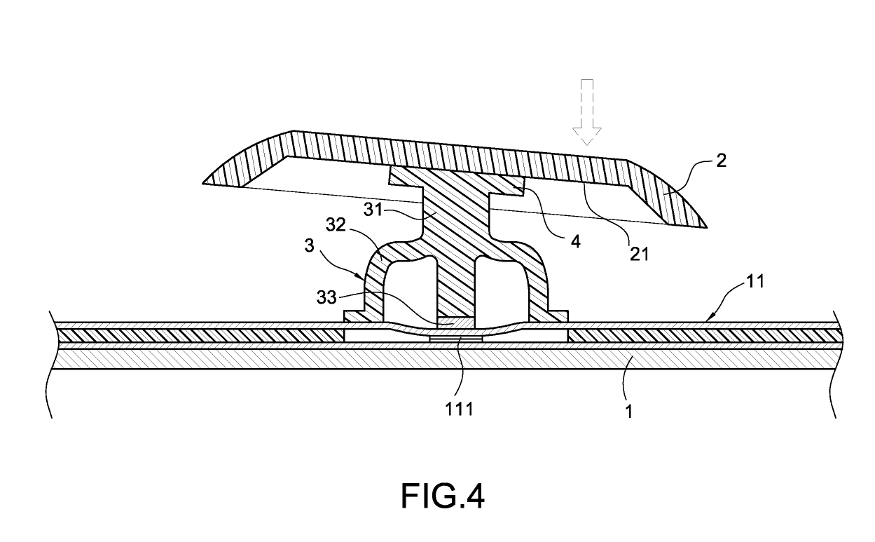

Please refer to FIGS. 2 to 4. The present invention provides a key structure of a keyboard. The key structure includes a base plate 1, a keycap 2, and an elastic body 3.

The base plate 1 is provided with a membrane circuit board 11. The membrane circuit board 11 is provided with a membrane switch 111.

The keycap 2 is located above the base plate 1. The keycap 2 has a bottom surface 21.

The elastic body 3 is sandwiched between the base plate 1 and the keycap 2. The elastic body 3 has a neck portion 31. The neck portion 31 is formed into a cylindrical shape. One end of the neck portion 31 protrudes toward the base plate 1 to form a bowl-shaped support 32. The other end of the neck portion 31 extends toward the keycap 2 to form a flange 4. The flange 4 is integrally formed with the elastic body 3 by means of an injection molding process. The outer peripheral dimension b of the flange 4 is larger than the outer peripheral dimension of the neck portion 31. The inner peripheral dimension a of the bowl-shaped support 32 is larger than or equal to the outer peripheral dimension b of the flange 4. The flange 4 is arranged to correspond to the center of the bottom surface 21 of the keycap 2. Further, the neck portion 31 extends toward the interior of the bowl-shaped support 32 to form a pressing portion 33. The pressing portion 33 is provided at a position corresponding to the membrane switch 111. A separation space is formed between the pressing portion 33 and the membrane switch 111. By this arrangement, when the keycap 2 is pressed, the bowl-shaped support 32 generates an elastic deformation to make the pressing portion 33 to abut against the membrane switch 111, thereby generating a signal corresponding to the action of pressing the keycap 2.

According to the key structure of the present invention, the keycap 2 is disposed above the base plate 1. The elastic body 3 is sandwiched between the base plate 1 and the keycap 2. The elastic body 3 has a neck portion 31. One end of the neck portion 31 protrudes toward the base plate 1 to form a bowl-shaped support 32. The other end of the neck portion 31 extends toward the keycap 2 to form a flange 4. The outer peripheral dimension b of the flange 4 is larger than the outer peripheral dimension of the neck portion 31. Since the outer peripheral dimension b of the flange 4 is larger than the outer peripheral dimension of the neck portion 31, and the flange 4 is sandwiched between the keycap 2 and the neck portion 31, the flange 4 can exert an even force to the neck portion 31 even though the keycap 2 is subjected to an uneven external force, thereby preventing the neck portion 31 from deforming, inclining or swaying and thus preventing the pressing portion 33 from deforming, inclining or swaying. Thus, the pressing portion 33 can abut against the membrane switch 111 accurately. In this way, the convenience in using the keyboard and the stability during its operation can be increased greatly. Further, since the flange 4 exerts an even force to the neck portion 31, the neck portion 31 cannot generate a plastic deformation easily even though an uneven external force is exerted to the keycap 2 for a long period of time, so that the lifetime of the key structure of the present invention can be extended. On the other hand, the inner peripheral dimension a of the bowl-shaped support 32 is larger than or equal to the outer peripheral dimension b of the flange 4. By this arrangement, when the keycap 2 is pressed, the flange 4 causes the bowl-shaped support 32 to generate a deformation and makes the bottom area of the elastic body 3 to be larger than the top area of the elastic body 3. In this way, uneven distribution of the gravity force of the elastic body 3, i.e. a “top-heavy” phenomenon causing the swaying of the flange 4, can be avoided. Thus, the stability of the elastic body 3 can be increased.

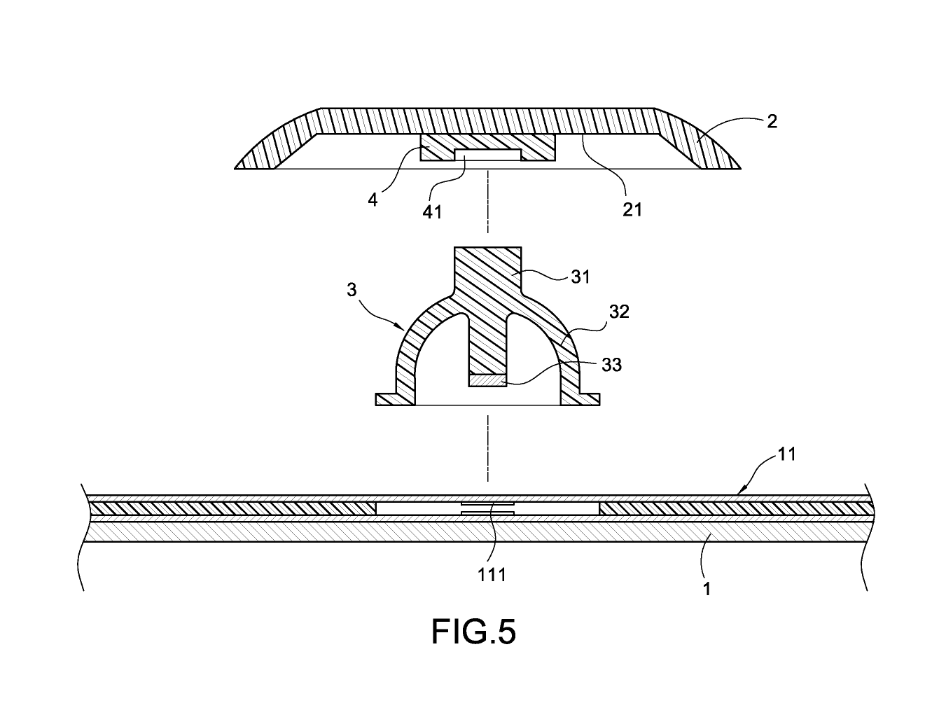

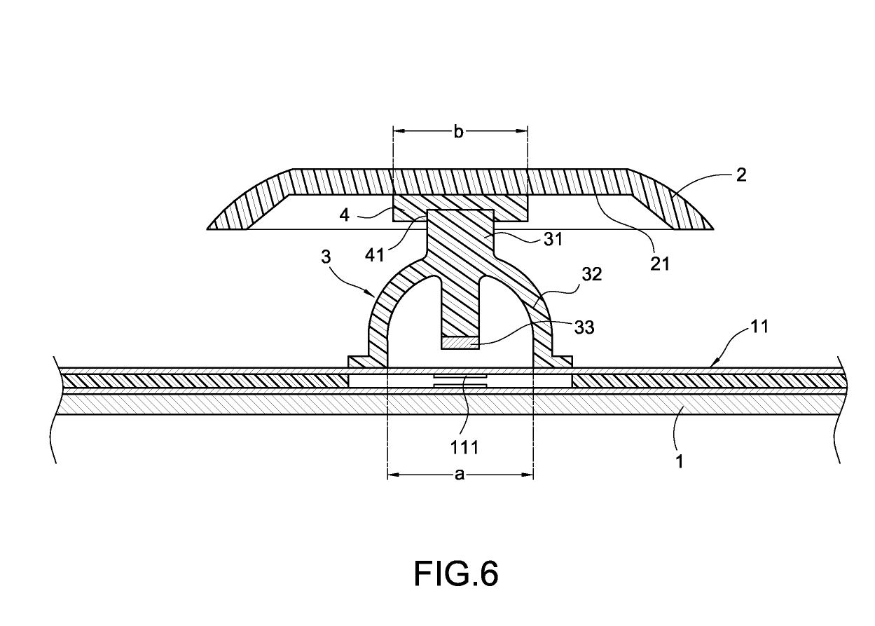

Please refer to FIGS. 5 to 6, which show the key structure of another embodiment of the present invention. The key structure includes a base plate 1, a keycap 2, an elastic body 3, and a flange 4.

The base plate 1 is provided with a membrane circuit board 11. The membrane circuit board 11 is provided with a membrane switch 111.

The keycap 2 is located above the base plate 1. The keycap 2 has a bottom surface 21.

The elastic body 3 is sandwiched between the base plate 1 and the keycap 2. The elastic body 3 has a neck portion 31. The neck portion 31 is formed into a cylindrical shape. One end of the neck portion 31 protrudes toward the base plate 1 to form a bowl-shaped support 32. The neck portion 31 extends toward the interior of the bowl-shaped support 32 to form a pressing portion 33. The pressing portion 33 is provided at a position corresponding to the membrane switch 111. A separation space is formed between the pressing portion 33 and the membrane switch 111. By this arrangement, when the keycap 2 is pressed, the bowl-shaped support 32 generates an elastic deformation to make the pressing portion 33 to abut against the membrane switch 111 accurately, thereby generating a signal corresponding to the action of pressing the keycap 2.

The flange 4 is fixed to the keycap 2. The outer peripheral dimension b of the flange 4 is larger than the outer peripheral dimension of the neck portion 31. The flange 4 is provided with an engaging portion 41. The engaging portion 41 is recessed for allowing the neck portion 31 to be engaged there with, thereby sandwiching the flange 4 between the keycap 2 and the neck portion 31. The inner peripheral dimension a of the bowl-shaped support 32 is larger than or equal to the outer peripheral dimension b of the flange 4. The flange 4 is disposed in the center of the bottom surface 21 of the keycap 2.

By this arrangement, the outer peripheral dimension b of the flange 4 is larger than the outer peripheral dimension of the neck portion 31. The flange 4 is sandwiched between the keycap 2 and the neck portion 31. Further, the inner peripheral dimension a of the bowl-shaped support 32 is larger than or equal to the outer peripheral dimension b of the flange 4. By this arrangement, the present embodiment can achieve the same effects and functions as those in the previous embodiment.

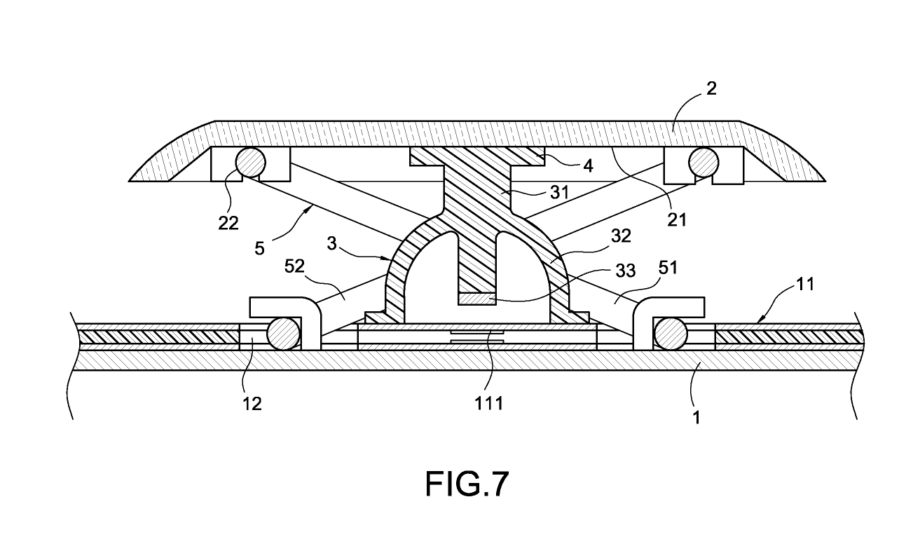

Please refer to FIG. 7, which shows the key structure of a further embodiment of the present invention. In the present embodiment, the key structure further includes a supporting element 5 comprising a first supporting frame 51 and a second supporting frame 52 pivotally intersecting with each other. The keycap 2 is provided with two engaging troughs 22 corresponding to two sides of the supporting element 5. The base plate 1 is provided with two grooves 12 corresponding to the other two sides of the supporting element 5. One end of the first supporting frame 51 is pivotally connected to the engaging trough 22, and the other end of the first supporting frame 51 is slidably disposed in the groove 12. One end of the second supporting frame 52 is pivotally connected to the engaging trough 22, and the other end of the second supporting frame 52 is slidably disposed in the groove 12. By this arrangement, when the keycap 2 is pressed, the keycap 2 is moved vertically toward the base plate 1 together with the supporting element 5. Thus, when the keycap 2 moves up and down, the key structure of the present embodiment can prevent the keycap 2 and the elastic body 3 from swaying leftwards or rightwards. Thus, the convenience in use, the stability in operation, and the lifetime of the key structure can be improved greatly.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A key structure of a keyboard, including:
a base plate;
a keycap; and
an elastic body sandwiched between the base plate and the keycap, the elastic body having a neck portion, one end of the neck portion being provided with a bowl-shaped support toward the base plate, the other end of the neck portion being provided with a flange extending toward the keycap, the outer peripheral dimension of the flange being larger than that of the outer peripheral dimension of the neck portion.

2. The key structure of a keyboard according to claim 1, wherein the inner peripheral dimension of the bowl-shaped support is larger than or equal to the outer peripheral dimension of the flange.

3. The key structure of a keyboard according to claim 1, wherein the keycap has a bottom surface, and the flange is disposed in the center of the bottom surface of the keycap.

4. The key structure of a keyboard according to claim 1, wherein a membrane circuit board is provided on the base plate, the membrane circuit board is provided with a membrane switch, the neck portion extends toward the interior of the bowl-shaped support to form a pressing portion, and the keycap is pressed to cause the pressing portion to abut against the membrane switch.

5. The key structure of a keyboard according to claim 1, further including a supporting element, wherein the supporting element comprises a first supporting frame and a second supporting frame pivotally intersecting with each other, the keycap is provided with two engaging troughs corresponding to two sides of the supporting element, the base plate is provided with two grooves corresponding to the other two sides of the supporting element, one end of the first supporting frame is pivotally connected to the engaging trough, and the other end of the first supporting frame is slidably disposed in the groove, one end of the second supporting frame is pivotally connected to the engaging trough, and the other end of the second supporting frame is slidably disposed in the groove.

6. A key structure of a keyboard, including:
a base plate;
a keycap;
an elastic body sandwiched between the base plate and the keycap, the elastic body having a neck portion, one end of the neck portion being provided with a bowl-shaped support toward the base plate; and
a flange fixed to the keycap, the outer peripheral dimension of the flange being larger than that of the outer peripheral dimension of the neck portion, the flange being provided with an engaging portion, the engaging portion being engaged with the neck portion, thereby clamping the flange between the keycap and the neck portion.

7. The key structure of a keyboard according to claim 6, wherein the inner peripheral dimension of the bowl-shaped support is larger than or equal to the outer peripheral dimension of the flange.

8. The key structure of a keyboard according to claim 6, wherein the keycap has a bottom surface, and the flange is disposed in the center of the bottom surface of the keycap.

9. The key structure of a keyboard according to claim 6, wherein a membrane circuit board is provided on the base plate, the membrane circuit board is provided with a membrane switch, the neck portion extends toward the interior of the bowl-shaped support to form a pressing portion, and the keycap is pressed to cause the pressing portion to abut against the membrane switch.

10. The key structure of a keyboard according to claim 6, further including a supporting element, wherein the supporting element comprises a first supporting frame and a second supporting frame pivotally intersecting with each other, the keycap is provided with two engaging troughs corresponding to two sides of the supporting element, the base plate is provided with two grooves corresponding to the other two sides of the supporting element, one end of the first supporting frame is pivotally connected to the engaging trough, and the other end of the first supporting frame is slidably disposed in the groove, one end of the second supporting frame is pivotally connected to the engaging trough, and the other end of the second supporting frame is slidably disposed in the groove.
